(19) United States
(12) Patent Application Publication
(10) Pub. No.: US 2011/0026069 A1
(43) Pub. Date: Feb. 3, 2011

(54) SYSTEMS AND METHODS FOR PERFORMING AN IMAGING OPERATION USING A WIRELESS REMOVABLE STORAGE DEVICE

(75) Inventors: Basil Isaiah Jesudason, Portland, OR (US); Stephen W. Ellis, Portland, OR (US); Alex Lane Johnson, Washougal, WA (US); Gary Lin Gaebel, Vancouver, WA (US)

Correspondence Address: AUSTIN RAPP & HARDMAN, 170 SOUTH MAIN STREET, SUITE 735, SALT LAKE CITY, UT, 84101, US

(73) Assignee: Sharp Laboratories of America, Inc., Camas, WA (US)

(21) Appl. No.: 12/533,380

(22) Filed: Jul. 31, 2009

(51) Int. Cl. G06F 3/12

(52) U.S. Cl. 358/1.15

(57) ABSTRACT

A method for performing an imaging operation using a wireless removable storage device is described. A wireless removable storage device is connected to an imaging device. The wireless removable storage device comprises a wireless transceiver for wireless communications, memory and a communications port for connecting to other devices. Wireless communications are established between the wireless removable storage device and a mobile computing device. An imaging operation is performed relating to a document file, and the document file is communicated between the wireless removable storage device and the imaging device. The document file is also communicated between the wireless removable storage device and the mobile computing device.

### TECHNICAL FIELD

The present invention relates generally to computers and computer-related technology. More specifically, the present invention relates to systems and methods for performing an imaging operation using a wireless removable storage device.

### BACKGROUND

Computer and communication technologies continue to advance at a rapid pace. Indeed, computer and communication technologies are involved in many aspects of a person's day. For example, many devices being used today by consumers have a small computer incorporated within the device. These small computers come in varying sizes and degrees of sophistication. These small computers may vary in sophistication from one microcontroller to a fully-functional complete computer system. For example, small computers may be a one-chip computer, such as a microcontroller; a one-board type of computer, such as a controller; a typical desktop computer, such as an IBM-PC compatible, etc.

Printers are used with computers to print various kinds of items including letters, documents, pictures, etc. Many different kinds of printers are commercially available. Ink jet printers and laser printers are fairly common among computer users. Ink jet printers propel droplets of ink directly onto the paper. Laser printers use a laser beam to print.

Printers are a type of imaging device. Imaging devices include, but are not limited to, physical printers, multi-functional peripherals, a printer pool, a printer cluster, a fax machine, a plotter, a scanner, a logical device, an electronic whiteboard, a tablet PC, a computer monitor, a file, etc.

Different kinds of computer software facilitate the use of imaging devices. The computer or computing device that will be used to print the materials typically has one or more pieces of software running on the computer that enable it to send the necessary information to the printer to enable printing of the materials. If the computer or computing device is on a computer network there may be one or more pieces of software running on one or more computers on the computer network that facilitate printing.

Information or data that is to be sent to an imaging device may come from a variety of devices, including, but not limited to, mobile computing devices and/or removable storage devices. Mobile computing devices and removable storage devices enable computer users to easily take electronic data from one place to another. Benefits may be realized by providing systems and methods for printing using a mobile device and/or removable storage.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 is a block diagram illustrating an embodiment of a system for performing an imaging operation using a wireless removable storage device;

FIG. 2 is a flow diagram of an embodiment of a method for performing an imaging operation using a wireless removable storage device;

FIG. 3 is a block diagram illustrating another embodiment of a system for performing an imaging operation using a wireless removable storage device;

FIG. 4 is a flow diagram illustrating another embodiment of a method for performing an imaging operation using a wireless removable storage device;

FIG. 5 is a flow diagram illustrating another embodiment of a method for performing an imaging operation using a wireless removable storage device;

FIG. 6 is a block diagram illustrating another embodiment of a system for performing an imaging operation using a wireless removable storage device; and

FIG. 7 is a block diagram illustrating the major hardware components typically utilized with embodiments herein.

### DETAILED DESCRIPTION

A method for performing an imaging operation using a wireless removable storage device is described. A wireless removable storage device is connected to an imaging device. The wireless removable storage device comprises a wireless transceiver for wireless communications, memory and a communications port for connecting to other devices. Wireless communications are established between the wireless removable storage device and a mobile computing device. An imaging operation is performed relating to a document file, and the document file is communicated between the wireless removable storage device and the imaging device. The document file is also communicated between the wireless removable storage device and the mobile computing device.

The imaging operation may include printing the document file, and communicating the document file may include receiving, by the wireless removable storage device, the document file from the mobile computing device, and communicating the document file from the wireless removable storage device to the imaging device for printing. A print command may be received at the imaging device. The imaging device may be a multi-functional peripheral (MFP).

The imaging operation may include scanning a document into the document file, and communicating the document file may include communicating the document file from the imaging device to the wireless removable storage device, and communicating the document file from the wireless removable storage device to the mobile computing device. A scan command may be received at the imaging device.

A file system of the wireless removable storage device may be exposed to the imaging device so that the file system can be browsed at a front panel of the imaging device. A file system of the mobile computing device may be exposed to the imaging device through the wireless removable storage device so that the file system of the mobile computing device can be browsed at a front panel of the imaging device.

The wireless removable storage device may include a Universal Serial Bus (USB) flash drive. Connecting may include inserting the wireless removable storage device into a local Universal Serial Bus (USB) port on the imaging device. The wireless removable storage device may use various types of wireless connections including a Bluetooth wireless connection and/or an infrared wireless connection.

A wireless removable storage device is also described. The wireless removable storage device includes a wireless transceiver for wireless communications and a communications port for connecting to other devices. The wireless removable storage device also includes a processor and memory in electronic communication with the processor. Instructions are stored in the memory and are executable to connect to an imaging device using the communications port and to establish wireless communications with a mobile computing device. The instructions are also executable to communicate a document file that relates to an imaging operation between the wireless removable storage device and the imaging device using the communications port, and to communicate the document file between the wireless removable storage device and the mobile computing device using the wireless transceiver.

Various embodiments of the invention are now described with reference to the Figures, where like reference numbers indicate identical or functionally similar elements. The embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments.

Where the described functionality is implemented as computer software, such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

As used herein, the terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not necessarily all) embodiments of the disclosed invention(s)”, unless expressly specified otherwise.

The phrase “based on” does not mean “based only on,” unless expressly specified otherwise. In other words, the phrase “based on” describes both “based only on” and “based at least on.”

The present systems and methods may provide solutions to various problems. For example, consider the case of a salesperson who needs to print a document from his/her laptop computer to the customer's MFP (multi-functional printer/product/peripheral). To accomplish this task, typically one would require that the laptop be connected to the customer's local area network. However, connecting to the customer's local area network presents a number of problems, some of which will now be described. One problem is that it assumes that the mobile device is able to connect easily to the local network or to the Internet. A further problem is that it assumes that the printing or scanning device is on the local network or the Internet. It assumes that the necessary security and privacy implications in routing a document through the network are automatically resident in the network. This may or may not be true, and is unknown in public environments where one might be printing using a public connection to the Internet (Wi-Fi hot spot for example). A yet further problem is that there are configuration issues that may be cumbersome and difficult to overcome (e.g., how does one find the printer, select it, and communicate with it). Additionally, there are network latency issues that may not be acceptable to the task at hand. In other words it might take a long time to print a document if it has to go through the network. Finally, network access via a cellular network has associated costs. In short, there are many challenges to moving files between mobile devices and printers/MFPs.

Today, interaction between a mobile device and a printer/MFP is difficult. Handheld devices, with their scaled-down operating systems, don't always have built-in printing capabilities. Laptops can print, but only if the user can find a printer, connect to it and install the right driver.

Drivers may perform several tasks at once. They process and format documents, and they also include device drivers to control specific printers. However, mobile devices don't usually have the correct driver on them when you consider the myriad of printers that a truly mobile user might come across in their travels.

Saving a document to disk from a mobile device and visiting a copy shop to print the content isn't always convenient or practical either. It also isn't possible for devices that don't have a disc or CD-R (Compact Disc-Recordable) drive (or other type of CD/DVD burner).

Currently there are programs that work on specific handheld devices that have specific operating systems. They also print to specific printers. Just like with other software, they will not run properly on unsupported systems or with unsupported printers. This, however, is not a true mobile environment. Mobile users are transient, and want the ability to print to and scan from any printer or MFP, not just the ones that they have specific software or compatibility with.

Compounding the mobile user's experience with getting mobile devices to connect to and interact with printers/MFPs is the fact that documents printed from handheld devices don't always look like they do when printed from desktop or laptop computers. This is because handheld mobile devices don't have enough processing power to handle print output very well. The printing software often has to simplify or modify the document for printing. Also, since handhelds have less memory than laptops it can take longer for them to process print jobs.

The present systems and methods provide solutions for mobile users to perform imaging operations. Herein is disclosed a means to implement connectivity and interactivity between a mobile device and a printer/MFP (more broadly defined as an imaging device) for the purpose of sharing files from and to the mobile device. The systems herein reduce the barriers to mobile printing/scanning as mentioned previously, and enable mobile devices to quickly and easily share files to and from the printer/MFP without going through the Internet. Utilizing wireless technology, the systems and methods herein allow a mobile device to connect to and transfer content to and from the printer/MFP. Users can then print from the mobile device, and users can scan to the mobile device. One configuration of the present systems and methods capitalizes on the unexpected benefits of combining a pre-mated Bluetooth/USB (Universal Serial Bus) flash drive with a mobile device such that the two already have been discovered by each other and can communicate. The unexpected results come from the ability to mate these two in advance, and then use them in concert to communicate and interact with a printer/MFP.

Some benefits may be realized by use of the present systems and methods. Examples of possible benefits include the following. The mobile device does not need to have any printer drivers or printer-specific information. The driver software for the wireless communication is already part of the mobile device operating system. The mobile device does not have to worry about overloading the printer or checking to make sure that the printer is not too busy, etc. Transmitting a single file or retrieving a single file from the wireless removable storage device does not require much processing power. Most MFPs have USB drivers to read various kinds of file systems and can print common file formats like JPG, TIF, PDF, and XPS. If the wireless protocol being used is Bluetooth, beneficial security features are built into the Bluetooth specification. The present systems and methods also enable one-to-many connectivity between a mobile device and multiple endpoints, i.e. MFPs, computers, other devices. Certain configurations eliminate the need to go through a discovery and configuration process each time a connection is made to perform the particular function or the use case (such as mobile printing and scanning).

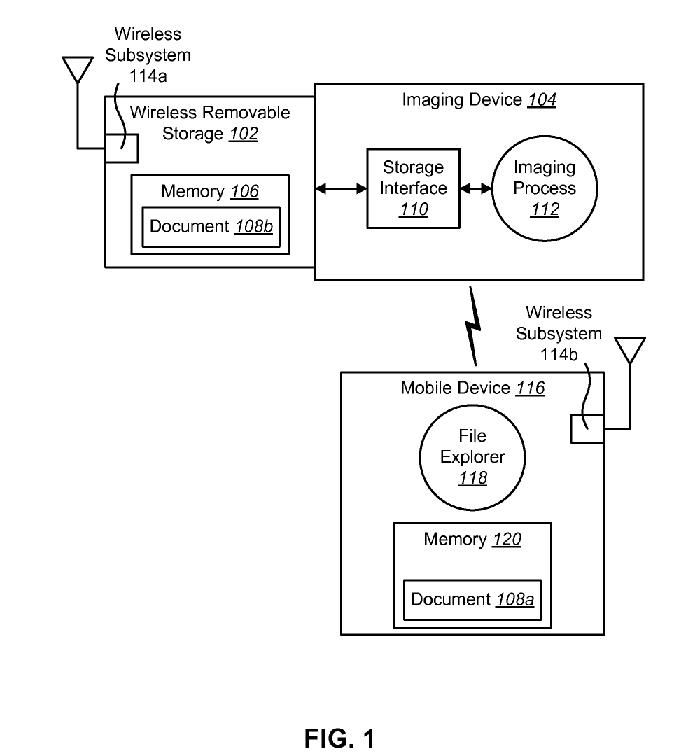

FIG. 1 is a block diagram illustrating an embodiment of a system for performing an imaging operation using a wireless removable storage device 102. A mobile computing device 116 is provided with one or more document files 108a, which are stored on the mobile device 116. Examples of a mobile computing device (“mobile device”) 116 include, but are not limited to, mobile Internet devices, Ultra Mobile PCs (UMPC), netbooks, laptops, Personal Digital Assistants (PDAs), smartphones, and cellular telephones.

At some point, a connection is established between the mobile device 116 and the wireless removable storage device 102. Various kinds of wireless connections may be used. For example, Bluetooth, IrDA (Infrared Data Association) or any short-hop low-power wireless protocol connection may be used. The mobile device 116 includes a wireless subsystem 114b for wireless communications. The wireless removable storage device 102 also includes a wireless subsystem 114a for wireless communications. The wireless subsystem 114 includes a transmitter and a receiver (the combination of which will be referred to herein as a wireless transceiver) capable of achieving the desired wireless communications.

IrDA may not have link-level security, so an encryption scheme and a security model may be added at the application side on the mobile device 116 as well as on the device application on the wireless removable storage device 102. Also, the data on the drive may not be encrypted, in which case there is no need to add layers to the IrDA since it is a point-to-point connection.

Various kinds of storage may be used in the wireless removable storage device 102. Removable storage for computing devices enables computer users to take electronic data from one place to another without requiring a more bulky computing device. There are many different kinds of removable storage media that can be used to store electronic data or information. One type of removable storage media is the USB (Universal Serial Bus) flash drive, sometimes referred to as a thumb drive or a memory stick. Most computers have USB ports, which allow memory sticks/USB flash drives to simply be plugged into the USB ports for access to the data that is stored on the memory stick/USB flash drive.

Using a file explorer application 118 on the mobile device 116, a document file 108a is then located on mobile device storage/memory 120. The file 108a is then wirelessly transferred from the mobile device 116 to the wireless removable storage 102. The wireless removable storage 102 then receives and stores the file(s) 108b in its memory/storage 106.

A wireless removable storage device 102 is then connected to an imaging device (MFP or printer) 104. Through a storage interface 110, the imaging device 104 may access and/or otherwise communicate with the wireless removable storage 102. The storage interface 110 includes hardware and software. For example, in the configuration where the wireless removable storage 102 is a wireless USB flash drive, the storage interface 110 may include the hardware for a USB port and the necessary software to communicate with the USB port and the wireless removable storage device 102.

Using the imaging device 104, a user may locate the file 108b on the wireless removable storage 102 and print the document 108b. The user may use a front panel of the imaging device 104 to browse/select the file 108b on the wireless removable storage device 102. An imaging process 112 is the software that may be involved on the imaging device 104 in browsing and selecting the file 108b. In an ideal scenario, a USB host application on the MFP 104 would alert the user through the front panel that a new file 108b is attached and is available for printing. The user may then walk up to the MFP 104 and select the file 108b by browsing the file system on the wireless removable storage device 102. In the case of scanning, the user may scan the document 108 and store it in the wireless removable storage device 102. Then he/she may launch the mobile device file explorer application 118 to retrieve the file 108b from the wireless removable storage device 102.

With respect to the imaging device 104, the exemplary operating environment includes multi-functional printers/products/peripherals (MFPs). In one embodiment, an MFP device 104 may include a copier, printer, scanner, facsimile machine (fax), media card reader, hard disk, etc. An MFP 104 may take either hardcopy or softcopy input and produce a hardcopy (e.g., copy/print) or softcopy (e.g., scan/fax) output. The MFP 104 additionally has one or more ports for accessing softcopy data from a removable media 102 (e.g., USB memory stick). The MFP 104 may additionally have internal filing storage.

One use case example is as follows. A user walks up to an MFP 104 and wishes to print a document 108a that is on his/her mobile device 116. He/she may plug in the wireless removable storage device 102 that may be powered by the MFP 104. The mobile device 116 may then communicate with the wireless removable storage device 102 and establish a link. The user may then start up an application, such as the file explorer 118, on the mobile device 116, browse to the file 108a that he/she wishes to print, and initiate the transfer of the file 108a to the storage device 102. The bytes may be streamed serially to the wireless removable storage device 102. The process/application that is running/resident on the processor or microcontroller on the wireless removable storage device 102 may wait until the entire file 108a is received successfully. At this point, the file 108a may be written to the memory 106 area that is exposed as a file system to the MFP 104. The user may then browse to the file 108b using the front panel of the MFP 104 and instruct the MFP 104 to print the document 108b.

The proposed solution may obviate the need for having a network for the user to use the imaging device 104 with his/her mobile computing device 116. Also, the proposed method is one-to-one between the mobile device 116 and the printer or scanner 104. This may be considerably faster than going through the Internet. An additional benefit is secure data transmission, since the wireless device 102 may be mated with the one single mobile device 116. In this particular case, only the owner of the mobile device 116 is able to use the wireless storage device 102 for mobile printing.

One particular configuration of the system shown in FIG. 1 may enable communicating between a mobile device 116 and a printer/MFP 104 using a point-to-point short distance (less than 30 ft.) wireless (for example, Bluetooth or IrDA-Data) device that has flash storage with a file system that can store documents. This may be a USB device that plugs into a MFP 104 when the user wishes to print or scan. The document 108 to be printed is sent from the mobile device (cell phone, PDA, etc.) 116 to this wireless flash device 102 where the document 108 is stored temporarily on its built-in flash file system. The document 108 is then available through the MFP 104 front panel for printing, since most MFPs 104 have built-in USB software to read files 108 in an attached USB flash device 102.

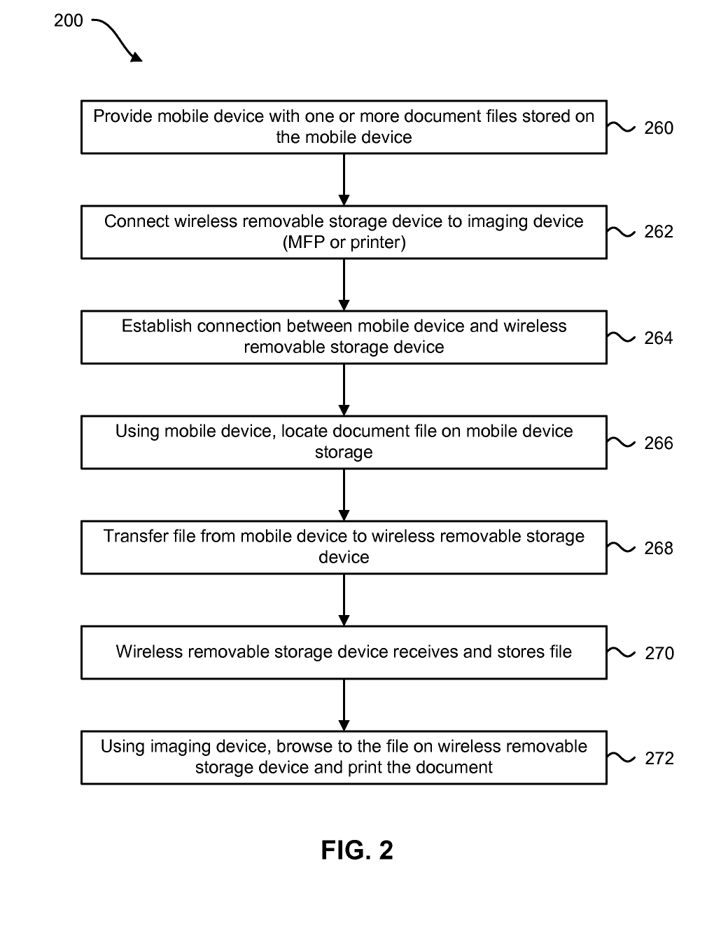

FIG. 2 is a flow diagram of an embodiment of a method 200 for performing an imaging operation using a wireless removable storage device 102. A mobile device 116 is provided 260 with one or more document files 108, which are stored on the mobile device 116. A wireless removable storage device 102 is then connected 262 to an imaging device (MFP or printer) 104. A connection is then established 264 between the mobile device 116 and the wireless removable storage device 102. Using the mobile device 116, a document file 108 is then located 266 on the mobile device storage 120. The file 108 is then transferred 268 from the mobile device 116 to the wireless removable storage device 102. Transmitting a single file 108 or retrieving a single file 108 from the wireless removable storage device 102 does not require much processing power. A simple application can stream the bytes over a serial wireless connection between the mobile device 116 and the wireless removable storage device 102. The wireless removable storage device 102 then receives 270 and stores the files 108. Using the imaging device 104, the file 108 is then browsed to 272 on the wireless removable storage device 102, and the document 108 is printed.

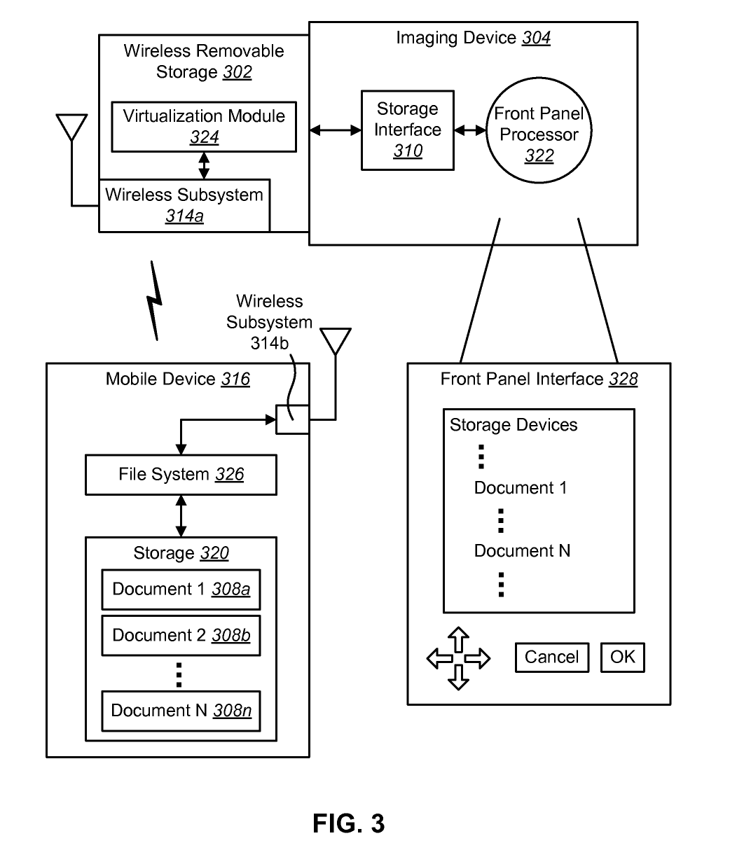

FIG. 3 is a block diagram illustrating another embodiment of a system for performing an imaging operation using a wireless removable storage device 302. FIG. 3 illustrates virtualization. In this particular configuration, the systems and methods expose the file system 326 on the mobile device 316 to the imaging device 304 through the wireless connection between the mobile device 316 and the wireless removable storage device 302. The wireless connection may be made through the wireless subsystems 314a, 314b. Then the files 308 (some or all depending on the settings and permissions) may be browsed from the front panel of the imaging device 304. This can be made visible in the MFP 304 in different ways. One way is to virtualize the mobile device storage 320 through the wireless removable storage device 302, where the file system 326 in the mobile device 316 is seen as a separate drive. Another way is to virtualize the mobile storage 320 drive through the wireless removable storage device 302, where the file system 326 in the mobile device 316 is seen in a special folder in the imaging device 304 storage system.

A virtualization module 324 on the wireless removable storage device 302 facilitates virtualization. The virtualization module 324 may access the storage 320 on the mobile device 316, discover which files 308 are available and make these files 308 available (e.g., list them) to the imaging device 304. Then, if and when any of these files 308 are selected at the imaging device 304, the virtualization module 324 may request them from the mobile device 316 and then provide them to the imaging device 304.

A mobile device 316 is provided with one or more document files 308, which are stored on the mobile device 316. A wireless removable storage device 302 is then connected to an imaging device (MFP or printer) 304. A connection is then established between the mobile device 316 and the wireless removable storage device 302. Document files 308 on the mobile device 316 are then discovered by the wireless removable storage device 302. The particular storage areas 320 on the mobile device 316 that may be discovered may be set by the user of the mobile device 316 (for example, he/she may share specific folders). The document files 308 are then exposed to the imaging device 304 by the wireless removable storage device 302 (virtualization). The imaging device 304 lists the document files 308 through the front panel interface 328 that may be handled by a front panel processor 322. The front panel processor 322 may be coupled to the storage interface 310 for communicating with the wireless removable storage device 302. The user then selects one or more document files 308 for imaging operations (e.g., printing). The selected files 308 are then copied from the mobile computing device 316 to the wireless removable storage 302, and then from the wireless removable storage 302 to the imaging device 304. The imaging device 304 then performs imaging operations.

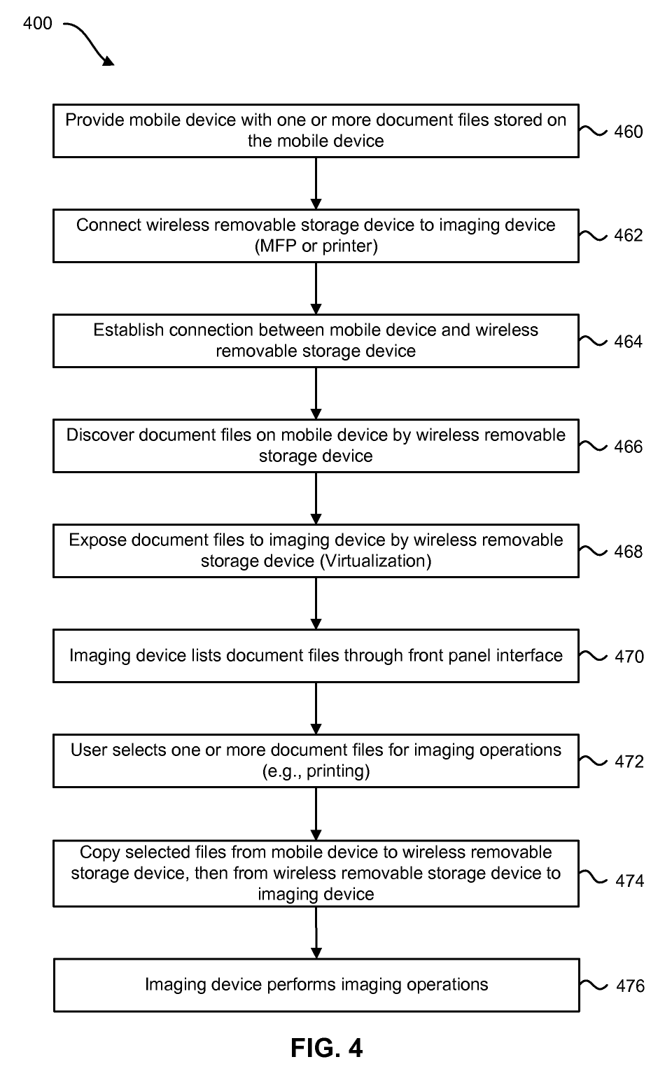

FIG. 4 is a flow diagram illustrating another embodiment of a method 400 for performing an imaging operation using a wireless removable storage device 102. A mobile device 116 is provided 460 with one or more document files, which are stored on the mobile device 116. A wireless removable storage device 102 is then connected 462 to an imaging device (MFP or printer) 104. A connection is then established 464 between the mobile device 116 and the wireless removable storage device 102. Document files 108 on the mobile device 116 are then discovered 466 by the wireless removable storage device 102. The document files 108 are then exposed 468 to the imaging device 104 by the wireless removable storage device 102 (virtualization). The imaging device 104 lists 470 the document files 108 through the front panel interface 328. The user then selects 472 one or more document files 108 for imaging operations (e.g., printing). The selected files 108 are then copied 474 from the mobile computing device 116 to the wireless removable storage device 102, and then from the wireless removable storage device 102 to the imaging device 104. In one configuration, this may be a pull operation in that the files 108 are pulled from the imaging device 104 as needed. The imaging device 104 then performs 476 imaging operations.

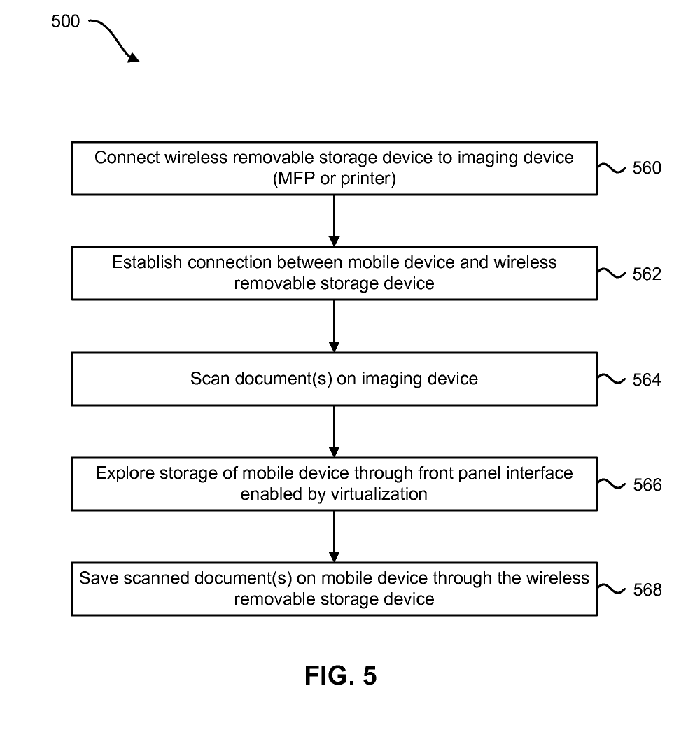

FIG. 5 is a flow diagram illustrating another embodiment of a method 500 for performing an imaging operation using a wireless removable storage device 102. FIG. 5 illustrates a scanning operation. A wireless removable storage device 102 is connected 560 to an imaging device (MFP or printer) 104. A connection is then established 562 between the mobile device 116 and the wireless removable storage device 102. One or more document(s) 108 are then scanned 564 on the imaging device 104. Storage 120 of the mobile device 116 is then explored 566 through the front panel interface 328 enabled by virtualization by the wireless removable storage device 102. The scanned document(s) 108 are then saved 568 on the mobile device 116 through the wireless removable storage device 102.

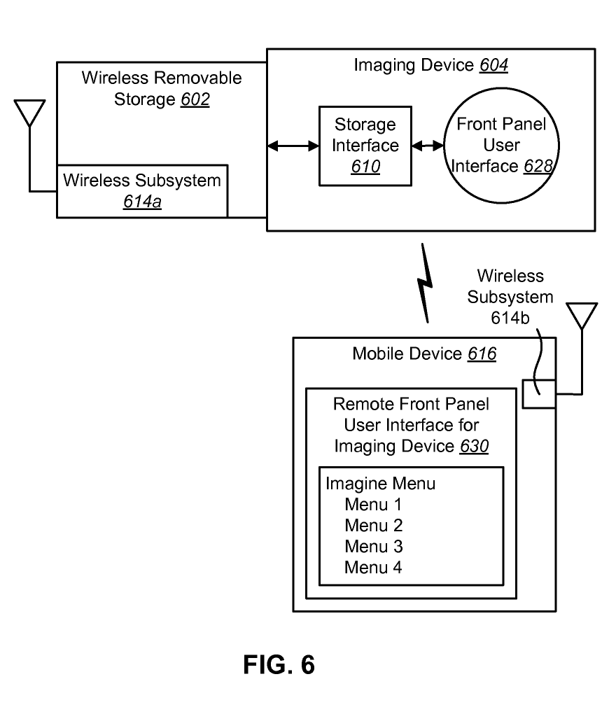

FIG. 6 is a block diagram illustrating another embodiment of a system for performing an imaging operation using a wireless removable storage device 602. In this particular configuration, the user may use the wireless removable storage device 602 and the mobile device 616 to display a front panel user interface 628 for the imaging device 604 on the mobile device 616. The information to create the user interface 628 is sent from the imaging device 604 to the wireless removable storage device 602, and then from the wireless removable storage device 602 to the mobile device 616. The information is sent wirelessly from the wireless removable storage device 602 to the mobile device 616 through use of the wireless subsystems 614a, 614b. The mobile device 616 then displays the remote front panel user interface 630. Inputs from the user are then received at the mobile device 616 and relayed to the imaging device 604 through the wireless removable storage device 602 and the storage interface 610.

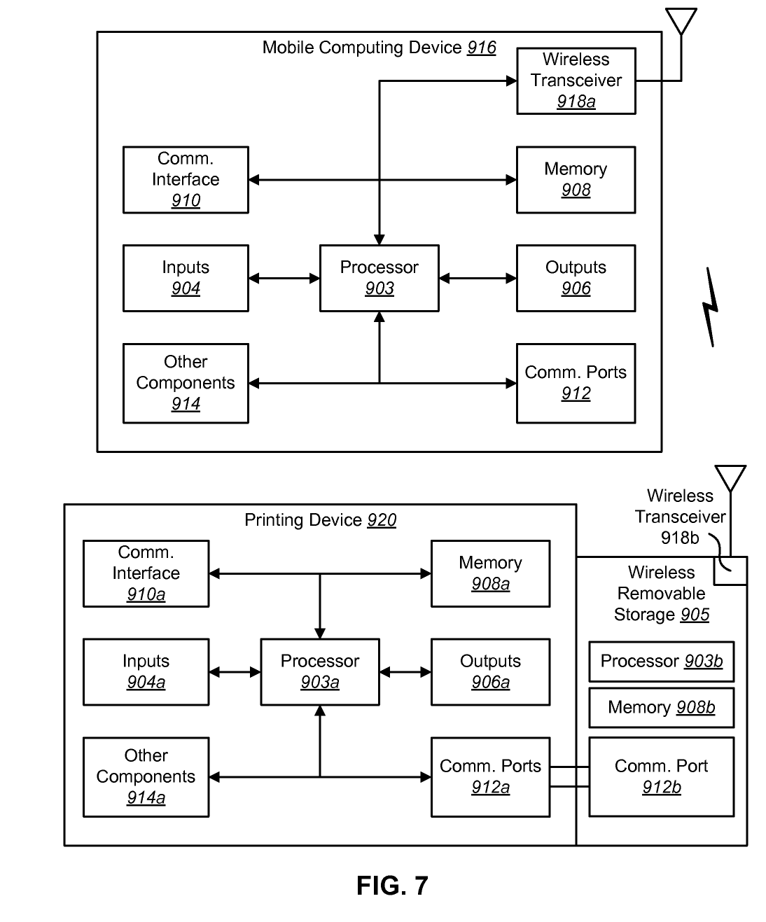

FIG. 7 is a block diagram illustrating the major hardware components typically utilized with embodiments herein. The systems and methods disclosed may be used with a mobile computing device 916 and a printing device 920, imaging device or MFP. The major hardware components typically utilized in a mobile computing device 916 are illustrated in FIG. 7. A computing device 916 typically includes a processor 903 in electronic communication with input components or devices 904 and/or output components or devices 906. The processor 903 is operably connected to input 904 and/or output devices 906 capable of electronic communication with the processor 903, or, in other words, to devices capable of input and/or output in the form of an electrical signal. Embodiments of devices 916 may include the inputs 904, outputs 906 and the processor 903 within the same physical structure or in separate housings or structures.

The computing device 916 may also include memory 908. The memory 908 may be a separate component from the processor 903, or it may be on-board memory 908 included in the same part as the processor 903. For example, microcontrollers often include a certain amount of on-board memory. The memory 908 may be any electronic component capable of storing electronic information. The memory 908 may be embodied as random access memory (RAM), read only memory (ROM), magnetic disk storage media, optical storage media, flash memory devices in RAM, on-board memory included with the processor, EPROM memory, EEPROM memory, an ASIC (Application Specific Integrated Circuit), registers, and so forth, including combinations thereof.

The processor 903 is also in electronic communication with a communication interface 910. The communication interface 910 may be used for communications with other devices 916, printing devices 920, servers, etc. Thus, the communication interfaces 910 of the various devices 916 may be designed to communicate with each other to send signals or messages between the computing devices 916.

The computing device 916 may also include other communication ports 912. In addition, other components 914 may also be included in the computing device 916.

The mobile computing device 916 may also include a wireless transmitter and a wireless receiver to allow wireless transmission and reception of data. The transmitter and receiver may be combined into a wireless transceiver 918a. An antenna is attached to the housing and electrically coupled to the transceiver 918a. Additional antennas may also be used.

Many kinds of different devices may be used with embodiments herein. The block diagram of FIG. 7 is only meant to illustrate typical components of a mobile computing device 916 and is not meant to limit the scope of embodiments disclosed herein.

As explained herein, the mobile computing device 916 may be in wireless communication with a wireless removable storage device 902. The wireless removable storage device 902 also includes a processor 903b (such as a microcontroller), memory 908b and a wireless transceiver 918b. The wireless removable storage device 902 also includes a communications port 912b for connecting to other devices, such as an imaging device 920.

The wireless removable storage device 902 may be connected to a printing device 920, imaging device or MFP. A printing device 920 includes a processor 903a, memory 908a, communications interface 910a, etc., as shown and illustrated in relation to FIG. 7. The component parts of the printing device 920 may be similar to the component parts mentioned with respect to the mobile computing device 916 understanding that the size and configuration of the components may be selected for use in an imaging device 920.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations that will be apparent to those skilled in the art may be made in the arrangement, operation, and details of the methods and systems of the present invention disclosed herein without departing from the spirit and scope of the invention.

What is claimed is:

1. A method for performing an imaging operation using a wireless removable storage: device, the method comprising:
connecting a wireless removable storage device to an imaging device, wherein the wireless removable storage device comprises a wireless transceiver for wireless communications, memory and a communications port for connecting to other devices;
establishing wireless communications between the wireless removable storage device and a mobile computing device; and
performing an imaging operation relating to a document file and communicating the document file between the wireless removable storage device and the imaging device, wherein the document file is also communicated between the wireless removable storage device and the mobile computing device.

2. The method of claim 1, wherein the imaging operation comprises printing the document file, and wherein communicating the document file further comprises:
receiving, by the wireless removable storage device, the document file from the mobile computing device; and
communicating the document file from the wireless removable storage device to the imaging device for printing.

3. The method of claim 2, further comprising receiving a print command at the imaging device.

4. The method of claim 2, further comprising exposing a file system of the wireless removable storage device to the imaging device so that the file system can be browsed at a front panel of the imaging device.

5. The method of claim 2, further comprising exposing a file system of the mobile computing device to the imaging device through the wireless removable storage device so that the file system of the mobile computing device can be browsed at a front panel of the imaging device.

6. The method of claim 1, wherein the imaging operation comprises scanning a document into the document file, and wherein communicating the document file further comprises:
communicating the document file from the imaging device to the wireless removable storage device; and
communicating the document file from the wireless removable storage device to the mobile computing device.

7. The method of claim 6, further comprising receiving a scan command at the imaging device.

8. The method of claim 1, wherein the imaging device is a multi-functional peripheral (MFP).

9. The method of claim 1, wherein the wireless removable storage device includes a Universal Serial Bus (USB) flash drive.

10. The method of claim 1, wherein connecting further comprises inserting the wireless removable storage device into a local Universal Serial Bus (USB) port on the imaging device.

11. The method of claim 1, wherein the wireless removable storage device uses a Bluetooth wireless connection.

12. The method of claim 1, wherein the wireless removable storage device uses an infrared wireless connection.

13. A wireless removable storage device comprising:
a processor;
a wireless transceiver for wireless communications;
a communications port for connecting to other devices;
memory in electronic communication with the processor;
instructions stored in the memory, the instructions being executable to:
connect to an imaging device using the communications port;
establish wireless communications with a mobile computing device; and
communicate a document file that relates to an imaging operation between the wireless removable storage device and the imaging device using the communications port, and communicate the document file between the wireless removable storage device and the mobile computing device using the wireless transceiver.

14. The wireless removable storage device of claim 13, wherein the imaging operation comprises printing the document file, and wherein the instructions to communicate the document file are further executable to:
receive the document file from the mobile computing device; and
communicate the document file to the imaging device for printing.

15. The wireless removable storage device of claim 14, further comprising instructions executable to expose a file system of the wireless removable storage device to the imaging device so that the file system can be browsed at a front panel of the imaging device.

16. The wireless removable storage device of claim 14, further comprising instructions executable to expose a file system of the mobile computing device to the imaging device through the wireless removable storage device so that the file system of the mobile computing device can be browsed at a front panel of the imaging device.

17. The wireless removable storage device of claim 13, wherein the imaging operation comprises scanning a document into the document file, and wherein the instructions to communicate the document file are further executable to:
receive the document file from the imaging device; and
communicate the document file to the mobile computing device.

18. The wireless removable storage device of claim 13, wherein the memory comprises a Universal Serial Bus (USB) flash drive.

19. The wireless removable storage device of claim 13, wherein the instructions executable to connect comprise instructions executable to establish communication through a Universal Serial Bus (USB) port.

20. The wireless removable storage device of claim 13, wherein the wireless transceiver is configured for a Bluetooth wireless protocol.

21. The wireless removable storage device of claim 13, wherein the wireless transceiver is configured for an infrared wireless connection.
